(19) United States
(12) Patent Application Publication
(10) Pub. No.: US 2025/0274897 A1
(43) Pub. Date: Aug. 28, 2025

(54) Training and Inference for AI-Based Positioning

(71) Applicant: Apple Inc., CUPERTINO, CA (US)

(72) Inventors: Oghenekome OTERI, San Diego, CA (US); Dawei ZHANG, Saratoga, CA (US); Haitong SUN, Saratoga, CA (US); Hong HE, San Jose, CA (US); Huaning NIU, San Jose, CA (US); Wei ZENG, Saratoga, CA (US); Weidong YANG, San Diego, CA (US); Yushu ZHANG, Beijing (CN)

(21) Appl. No.: 18/858,426

(22) PCT Filed: Apr. 29, 2022
(86) PCT No.: PCT/CN2022/090608

§ 371 Date: Oct. 21, 2024

(51) Int. Cl. H04W 64/00; H04L 5/00; H04L 41/16

(52) U.S. Cl. CPC H04W 64/00; H04L 5/0051; H04L 41/16

(57) ABSTRACT

A user equipment (UE) is configured to receive a configuration from a location management function (LMF) for an artificial intelligence (AI) based UE positioning method using a neural network (NN), wherein the LMF identifies a first training data set for training the NN and trains the neural network with the first training data set, receive a configuration for downlink (DL) reference signal (RS) reception on one or more positioning cells, estimate a channel response for the received DL RS from the one or more positioning cells, transmit the channel response to the LMF as the NN inference input, wherein the LMF estimates the UE position and receive the UE position estimation from the LMF.

### TECHNICAL FIELD

This application relates generally to wireless communication, and in particular relates to training and inference for AI-based positioning.

### BACKGROUND

5G New Radio (NR) has introduced many radio access network (RAN) and core network (CN) enhancements, as well as an enhanced security architecture. Artificial intelligence (AI) and/or machine learning (ML) processes, e.g., deep learning neural networks, may be used to augment operations for the air interface. The use cases for AI/ML for the air interface include channel state information (CSI) feedback enhancement (e.g., overhead reduction, improved accuracy, prediction); beam management (e.g., beam prediction in time, and/or spatial domain for overhead and latency reduction, beam selection accuracy improvement); and positioning accuracy enhancements for different scenarios including, e.g., those with heavy no line of site (NLOS) conditions.

### SUMMARY

Some exemplary embodiments aspects are related to a processor of a user equipment (UE) configured to perform operations. The operations include receiving a configuration from a location management function (LMF) for an artificial intelligence (AI) based UE positioning method using a neural network (NN), wherein the LMF identifies a first training data set for training the NN and trains the neural network with the first training data set, receiving a configuration for downlink (DL) reference signal (RS) reception on one or more positioning cells, estimating a channel response for the received DL RS from the one or more positioning cells, transmitting the channel response to the LMF as the NN inference input, wherein the LMF estimates the UE position and receiving the UE position estimation from the LMF.

Other exemplary embodiments are related to a location management function (LMF) of a cellular core network configured to perform operations. The operations include training a neural network (NN) using a first training data set for an artificial intelligence (AI) based user equipment (UE) positioning method, receiving, from a UE, a request for AI-based positioning, sending, to the UE, an NN inference input request comprising a configuration for downlink (DL) reference signal (RS) reception on one or more positioning cells, receiving, from the UE, a channel response for the received DL RS from the one or more positioning cells, wherein the channel response is the NN inference input and estimating the UE position using the NN based on the NN inference input.

Still further exemplary embodiments are related to a processor of a user equipment (UE) configured to perform operations. The operations include receiving a configuration from a location management function (LMF) for an artificial intelligence (AI) based UE positioning method using a neural network (NN), wherein the LMF identifies a first training data set for training the NN and trains the neural network with the first training data set, receiving a configuration for uplink (UL) reference signal (RS) transmission to one or more positioning cells, transmitting the UL RS to the one or more positioning cells and receiving a UE position estimation from the LMF.

### BRIEF DESCRIPTION OF THE DRAWINGS

FIG. 1 shows a network arrangement according to various exemplary embodiments.

FIG. 2 shows an exemplary UE according to various exemplary embodiments.

FIG. 3 shows a signaling diagram for AI-based UE positioning according to a first option where the training and inference phases of the AI processes are performed at the UE according to various exemplary embodiments.

FIG. 4 shows a signaling diagram for AI-based UE positioning according to a second option where the training and inference phases of the AI processes are performed at a location management function (LMF) according to various exemplary embodiments.

FIG. 5 shows a signaling diagram for AI-based UE positioning according to a third option where the training phase of the AI process is performed at the LMF and the inference phase of the AI process is performed at the UE according to various exemplary embodiments.

FIG. 6 shows a signaling diagram for channel response acquisition at the UE for identifying neural network (NN) inference input for UE positioning according to various exemplary embodiments.

FIG. 7 shows a signaling diagram for channel response acquisition at one or more positioning transmission and reception points (TRPs)/next generation NodeBs (gNBs) for identifying NN inference input for UE positioning at the LMF according to various exemplary embodiments.

FIG. 8 shows a method for AI-based UE positioning using a NN where the training and inference phases of the AI process are performed at the UE according to various exemplary embodiments.

FIG. 9 shows a method for AI-based UE positioning using a NN where the training and inference phases of the AI process are performed at the LMF according to various exemplary embodiments.

FIG. 10 shows a method for AI-based UE positioning using a neural network (NN) where the training phase of the AI process is performed at the LMF and the inference phase of the AI process is performed at the UE according to various exemplary embodiments.

### DETAILED DESCRIPTION

The exemplary aspects may be further understood with reference to the following description and the related appended drawings, wherein like elements are provided with the same reference numerals. The exemplary aspects describe operations for supporting artificial intelligence (AI) and/or machine learning (ML) based location estimation in a wireless network. In some aspects, a deep learning neural network (NN) is used to enhance positioning methods for locating a user equipment (UE). According to various embodiments, the training phase for the NN and the inference phase for the trained NN can be performed at the UE and/or the location management function (LMF) of the 5G New Radio (NR) core network (CN). In other aspects, operations are described for acquiring the channel response used as input for the inference phase of the trained NN.

As described above, the exemplary embodiments are described with reference to an LMF of a 5G New Radio (NR) core network (CN). However, it should be understood that the operations described herein are not limited to an LMF resident in the core network. For example, some positioning operations may be performed via a sidelink (SL) connection (e.g., SL positioning) in out-of-coverage scenarios. In these scenarios or any other scenario, the LMF may be resident outside of the core network, e.g., a SL LMF.

The exemplary aspects are described with regard to a UE. However, the use of a UE is provided for illustrative purposes. The exemplary aspects may be utilized with any electronic component that may establish a connection with a network and is configured with the hardware, software, and/or firmware to exchange information and data with the network. Therefore, the UE as described herein is used to represent any electronic component that is capable of accessing a wireless network and performing AI-based positioning methods to locate the UE.

The exemplary aspects are described with regard to the network being a 5G New Radio (NR) network and a base station being a next generation Node B (gNB). However, the use of the 5G NR network and the gNB are provided for illustrative purposes. The exemplary aspects may apply to any type of network that utilizes similar functionalities. For example, some positioning methods as described herein can be RAT-independent.

The exemplary embodiments are further described with regard to artificial intelligence (AI) and/or machine learning (ML) based location estimation. Any number of different AI/ML models may be used, depending on UE and network implementation. For example, a deep learning neural network may be used. Further, the various types of models may use different types of channel response data for training the model, as well as different types/densities of RS for the inference phase of the position estimation. Thus, reference to any particular AI-based location estimation model is provided for illustrative purposes. The exemplary aspects may apply to any type of AI-based location estimation model that uses a training phase and an inference phase that can be executed at a UE and/or a core network element, e.g., a location management function (LMF).

The exemplary embodiments are further described with regard to a location management function (LMF) of the 5G core network (5GC) to support location determinations for a target UE. As will be described further below, in the exemplary aspects described herein, the LMF may perform operations to facilitate the AI-based estimation of a UE location including: performing either one or both of an inference phase and a training phase of a positioning NN for locating the target UE; configuring RAN nodes and/or the UE to transmit/receive reference signals (RS) for channel response acquisition; and receiving/transmitting location estimation and/or channel response estimation feedback to/from the target UE. It should be understood that the LMF is not required to be in the core network. For example, the LMF may reside on a separate server(s) that are connected to the 5GC or may reside within the 5G RAN.

Throughout this description, it will be described that channel responses may be used to train the AI models, as input to the AI models, etc. It should be understood that the exemplary embodiments are not limited to channel responses. When the term channel response is used it may also refer to other types of data that may be used to train the AI models or as input to the models such as channel layer 1 received reference signal power (L1-RSRP), a channel power delay profile, a combination of the described inputs or any other input useful for determining the position of the UE.

In addition, throughout this description, a gNB may be referred to as a “serving cell.” A gNB that is acting as a serving cell is the cell to which a UE is currently connected, e.g., the UE may be in a Radio Resource Control (RRC) Connected state with the gNB and may be actively exchanging data and/or control information with the base station. A gNB may also be referred to as a “positioning gNB,” a “positioning node” or a “positioning cell.” A gNB acting as a positioning cell is a base station that is assisting in locating the UE, e.g., transmitting positioning reference signals (PRS) to the UE to assist in locating the UE. A gNB may simultaneously act as a serving cell and a positioning cell with respect to a UE or may act only as a positioning cell for a UE. Additionally, throughout this description a gNB may be referred to as a “neighbor cell” or “neighboring cell.” The neighboring cell, according to the present disclosure, may not act as a serving cell for the UE, however certain signals may be exchanged between the neighboring cell and the UE without entering the RRC Connected state. One or more neighboring cells may act as additional positioning gNBs to assist in locating the UE.

A serving cell or a neighbor cell acting as a positioning gNB may include one or more transmission and reception points (TRP), e.g., a first TRP and a second TRP. One or more of the TRPs located at a particular positioning gNB may be used in the exemplary positioning methods and may be referred to as a “positioning TRP.” Multiple positioning TRPs may be located at a single positioning gNB.

Furthermore, throughout this description, various positioning methods are described that are UE-based and/or UE-assisted, LMF based. These positioning methods may include downlink (DL)-based positioning, uplink (UL)-based positioning, or combined DL+UL-based positioning, including, without limitation: assisted global navigation satellite system (A-GNSS) (GPS); wireless local area network (WLAN); terrestrial beacon systems (TBS); downlink time difference of arrival (DL-TDOA); DL angle of departure (DL-AoD); and multi round trip time (multi-RTT). In some positioning methods, a positioning reference signal (PRS) is transmitted on the DL from each of multiple network nodes, i.e., positioning transmission and reception points (TRP), to the UE so that the DL arrival timings of the respective PRSs at the UE may be determined, and a location of the UE determined therefrom. Additionally, other types of reference signals may be used on the DL to locate the UE, including channel state information reference signals (CSI-RS) and/or synchronization signal blocks (SSB), e.g., demodulation RS (DMRS). Uplink (UL) reference signals may also be used to locate the UE, including sounding reference signals (SRS). Those skilled in the art will understand that these reference signals may also be used for other purposes in addition to locating the UE. Thus, the RS described herein are not limited to any specific type of reference signal.

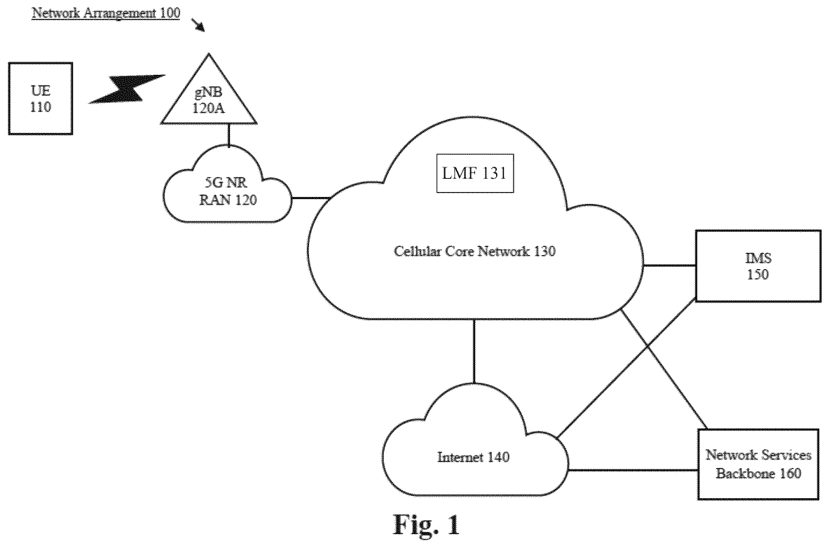

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., mobile phones, tablet computers, smartphones, phablets, embedded devices, wearable devices, Cat-M devices, Cat-M1 devices, MTC devices, eMTC devices, other types of Internet of Things (IoT) devices, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g. legacy cellular networks) and the UE 110 may also communicate with networks over a wired connection. With regard to the exemplary aspects, the UE 110 may establish a connection with the 5G NR-RAN 122.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN via at least one of the next generation nodeB (gNB) 120A and/or the gNB 120B. Reference to two gNBs 120A, 120B is merely for illustrative purposes. The exemplary aspects may apply to any appropriate number of gNBs.

In addition to the networks 120, 122 and 124 the network arrangement 100 also includes a cellular core network 130, the Internet 140, an IP Multimedia Subsystem (IMS) 150, and a network services backbone 160. The cellular core network 130, e.g., the 5GC for the 5G NR network, may be considered to be the interconnected set of components that manages the operation and traffic of the cellular network. The cellular core network 130 also manages the traffic that flows between the cellular network and the Internet 140. The core network 130 may include a location management function (LMF) 131 to support location determinations for a UE, as will be described further below.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

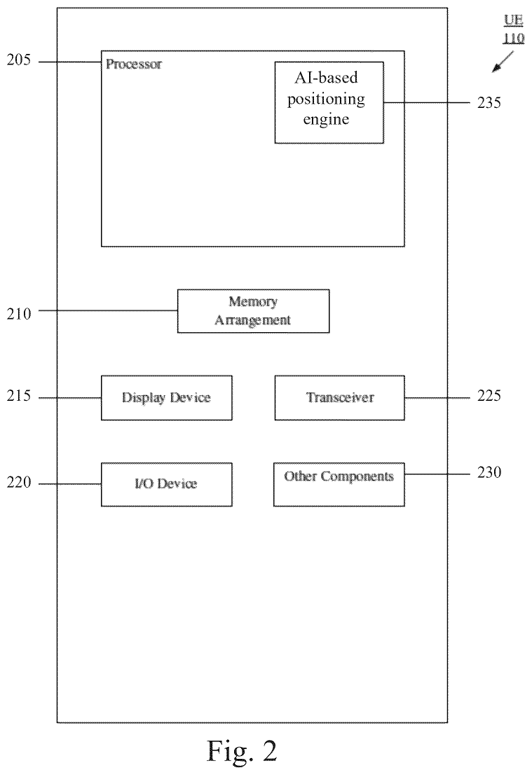

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc. Additionally, the UE 110 may be configured to access an SNPN.

The processor 205 may be configured to execute a plurality of engines for the UE 110. For example, the engines may include a location estimation engine 235 for performing operations related to performing a training phase and/or inference phase of a positioning neural network (NN) and acquiring a channel response as input for the inference phase, to be described in greater detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary aspects may be implemented in any of these or other configurations of a UE.

The memory 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies).

The exemplary network base station, in this case qNB 120A, may represent a serving cell for the UE 110. The gNB 120A may represent any access node of the 5G NR network through which the UE 110 may establish a connection and manage network operations. The gNB 120A may include a processor, a memory arrangement, an input/output (I/O) device, a transceiver, and other components. The other components may include, for example, an audio input device, an audio output device, a battery, a data acquisition device, ports to electrically connect the gNB 120A to other electronic devices, etc. The functionality associated with the processor of the gNB 120A may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor is split among a plurality of processors (e.g., a baseband processor, an applications processor, etc.). The exemplary aspects may be implemented in any of these or other configurations of a gNB.

The memory may be a hardware component configured to store data related to operations performed by the UEs 110, 112. The I/O device may be a hardware component or ports that enable a user to interact with the gNB 120A. The transceiver may be a hardware component configured to exchange data with the UE 110 and any other UE in the system 100. The transceiver may operate on a variety of different frequencies or channels (e.g., set of consecutive frequencies). Therefore, the transceiver may include one or more components (e.g., radios) to enable the data exchange with the various networks and UEs.

As described above, artificial intelligence (AI) and/or machine learning (ML), e.g., deep learning neural networks (NN), may be used to augment operations for the air interface, including positioning accuracy enhancements for different scenarios including, e.g., those with heavy no line of site (NLOS) conditions.

The general process for neural network-based operations includes a training phase, where training data is input into the NN to train the model, and an inference phase, where inference data is input into the trained NN for the NN to perform an estimation based on the input data. Additionally, a calibration phase may be used to assess the error of a trained NN and, if the error is sufficiently high, re-train the NN using different training data.

As described above, the LMF refers to a 5G core network (5GC) entity supporting location determinations of a target UE. The LMF may perform various operations to facilitate the AI-based location estimation including: configuring the UE for AI-based UE positioning; performing NN training/inference operations for the UE positioning; configuring RAN nodes (serving cells and/or positioning cells/TRPs) and/or the UE to transmit/receive reference signals (RS) for channel response acquisition; transmitting/receiving feedback from the UE and/or the gNBs to inform the location estimation; and other operations to be described in detail below. It should be understood that the LMF is a core network entity and that message between the UE and the LMF, transmitted via a positioning protocol, are routed via a gNB. Additionally, in some aspects, messages are transmitted directly to the gNB (serving gNB or positioning cell) from the UE or the LMF or are received from the gNB at the UE or the LMF. Thus, signaling exchanges may refer to either the LMF or the gNB as a transmitting/receiving entity for communications with the UE.

According to various exemplary embodiments described herein, the training and/or inference phases of the AI-based channel measurements can be performed at either the LMF or the UE. In a first option, both the training and inference are performed at the UE. In a second option, both the training and inference are performed at the LMF. In a third option, the training is performed at the LMF and the inference is performed at the UE. In a fourth option, the training is performed at the UE and the inference is performed at the LMF.

According to the first option, both the training and inference are performed at the UE. Relative to the further options to be described below, performing both phases at the UE provides the greatest UE privacy.

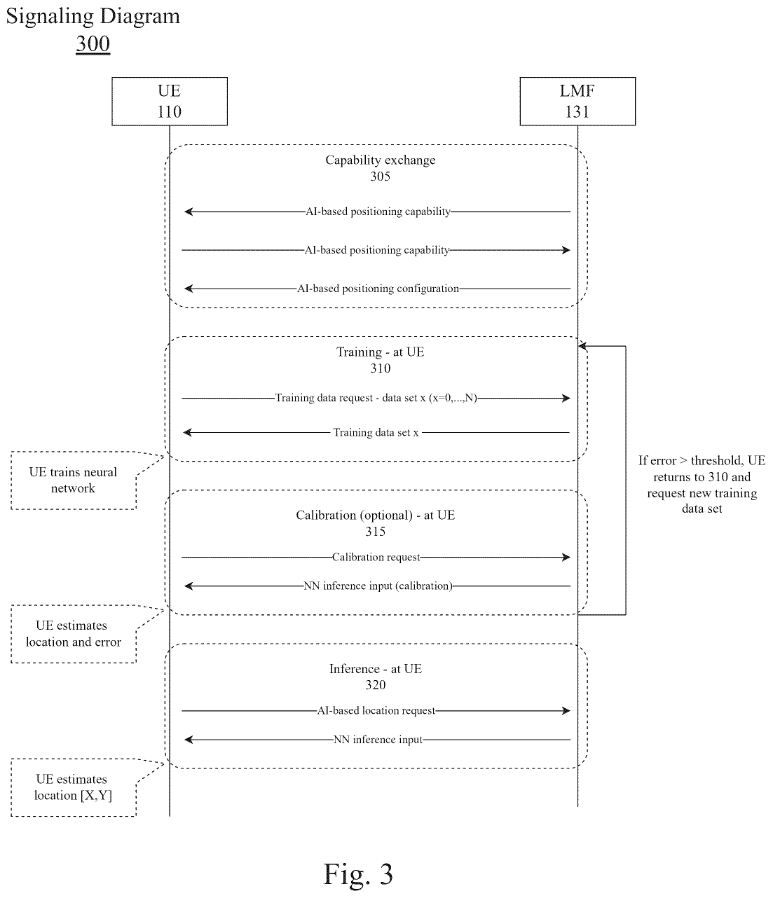

FIG. 3 shows a signaling diagram 300 for AI-based UE positioning according to a first option where the training and inference phases of the AI processes are performed at the UE according to various exemplary embodiments. The diagram 300 shows one example of the first option, however, various alternative embodiments will also be described.

Box 305 shows a capability signaling exchange between the UE and the gNB/LMF to indicate UE and network capability. For example, the LMF 131 may signal support for AI-based positioning to the UE 110 and the UE 110 may report an AI-based positioning capability to the LMF 131. The LMF can configure the UE for the AI-based positioning process.

Box 310 shows a training phase for the AI-based positioning neural network (NN). The UE and the LMF can enter an initial training phase after the capability exchange. In some embodiments, as shown in 310, the UE sends a training data request to the LMF. In response, the UE receives a training data set from the LMF and the UE trains the NN based on the received training data set. The training data set can include information related to particular locations, channel conditions for the location, positioning parameters used for various positioning methods including reference signals, etc.

In one embodiment, after the initial capability exchange of 305, the UE may request a first training data set, e.g., data set index x=0 and the LMF may provide the data set x=0 in response to the request. In another embodiment, the initial request is optional, and the LMF can send the first training data set to the UE without a specific request from the UE. To be described in further detail below, if retraining of the NN is desired, the request step 310 can be repeated and indicate a different training set x (x=0, . . . , N) to calibrate the NN and reduce the model error. It should be understood that the respective training data sets that can be requested and received in 310 may be similar or different in composition.

The box 310 of the diagram 300 shows one example of the UE requesting and receiving training data for the positioning NN from the LMF via a gNB of the 5G RAN. However, other options are available for training the NN. In one alternative embodiment, the UE uses historical data to train the NN. For example, the historical data can relate to parameters for positioning methods previously used by the UE. In another alternative embodiment, the UE can download the training data from a reference point, e.g., a positioning reference defined in the network and associated with a location, or a kiosk. To provide an illustrative example, the UE can access a kiosk/terminal in a location that may have poor positioning performance when AI is not used, e.g., an airport. The UE can communicate with the kiosk to receive a high speed download of the training data for the NN. This can be performed while the UE is connected to the 5G RAN or offline with respect to the 5G RAN. When the UE identifies the training data, the UE can train the NN.

Box 315 shows an optional calibration phase for the AI-based positioning neural network. The calibration can be performed in various scenarios, e.g., when the UE was recently powered on in a new location, and does not need to be performed after every training phase. For the calibration phase, the UE can use an existing positioning mechanism to determine a calibration location to compare to the AI-based position estimation. The accuracy of the AI model relative to the calibration location can be assessed within some error threshold. For example, in some embodiments, the UE can identify a calibration location [X, Y] based on any of the UE-based RAT-independent techniques (e.g., GNSS or GPS) or (b) RAT-dependent techniques (e.g., time difference of arrival (TDOA)) defined in 3GPP Rel-16 or Rel-17. In other embodiments, the calibration location [X, Y] can be downloaded manually, e.g., from the positioning reference unit defined in the network and associated with a location described above.

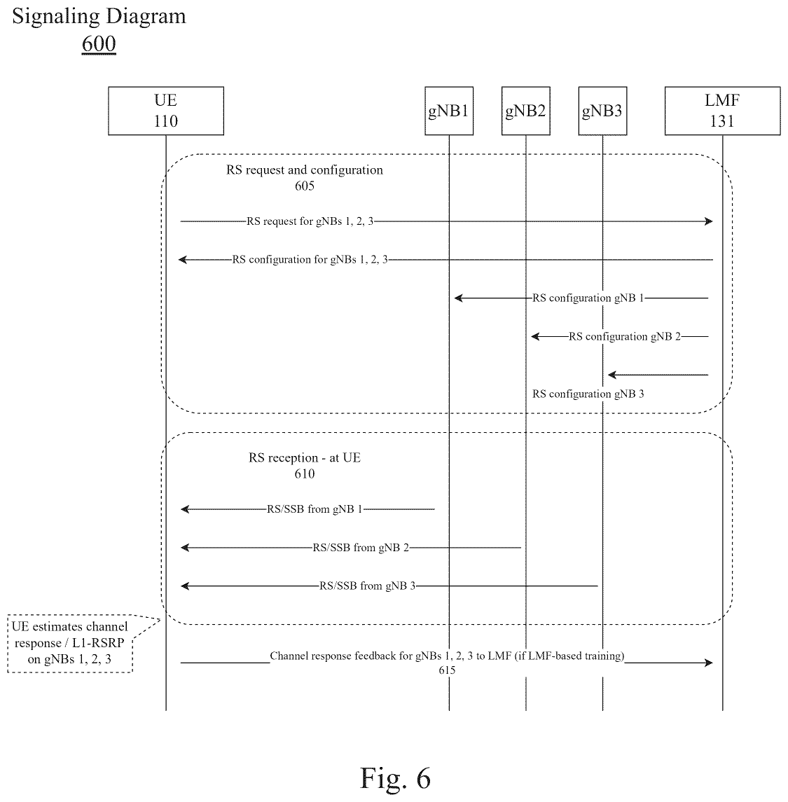

To perform the AI-based position determination, the UE requests for neural network inference input for the calibration phase comprising a channel response, e.g., L1-RSRP, beam direction, etc. To be described in further detail below relative to FIG. 6, the request can indicate particular TRPs, frequencies, or RS to transmit to the UE so that the UE can estimate the channel response. The channel response can be used as input data for a calibration inference phase of the NN to estimate the UE location and error relative to the calibration location. The UE can determine a single location, or the determination can be based on multiple tests of the NN. If the error is greater than a pre-determined threshold value, the UE can return to the training phase of 310 and transmit a new request for a training data set, e.g., data set index x=1.

In alternative embodiments, the receipt of the training and/or calibration location can be done offline. In some embodiments, the LMF can send the training data and the calibration data (e.g., calibration location) in a combined transmission.

Box 320 shows an inference phase for the AI-based positioning neural network. After the NN is trained and optionally calibrated, the NN can be used for UE-based positioning. Similar to the optional calibration phase 315 discussed above, the UE transmits a request for NN inference input, e.g., some reference signals from which the UE can derive the channel response parameters that are input into the trained NN. The UE receives the NN inference input from the LMF and estimates the UE location [X, Y], to be explained in greater detail below.

The RS used for the NN inference input can be periodic, aperiodic or semi-persistent. After one or more positioning estimations, the UE may report the preferred TRP/cell ID for the reference signals, as well as the type of reference signal, e.g., CSI-RS for CSI, CSI-RS for beam management (BM), or PRS. The LMF instances used for training can be the same LMF instance or a different LMF instance than the LMF instance used for inference.

According to the second option for training/inference, both the training and inference are performed at the LMF. Relative to the first option, using the second option can reduce the UE processing. The LMF, as a trusted entity, can preserve UE privacy, although not as securely as the first option.

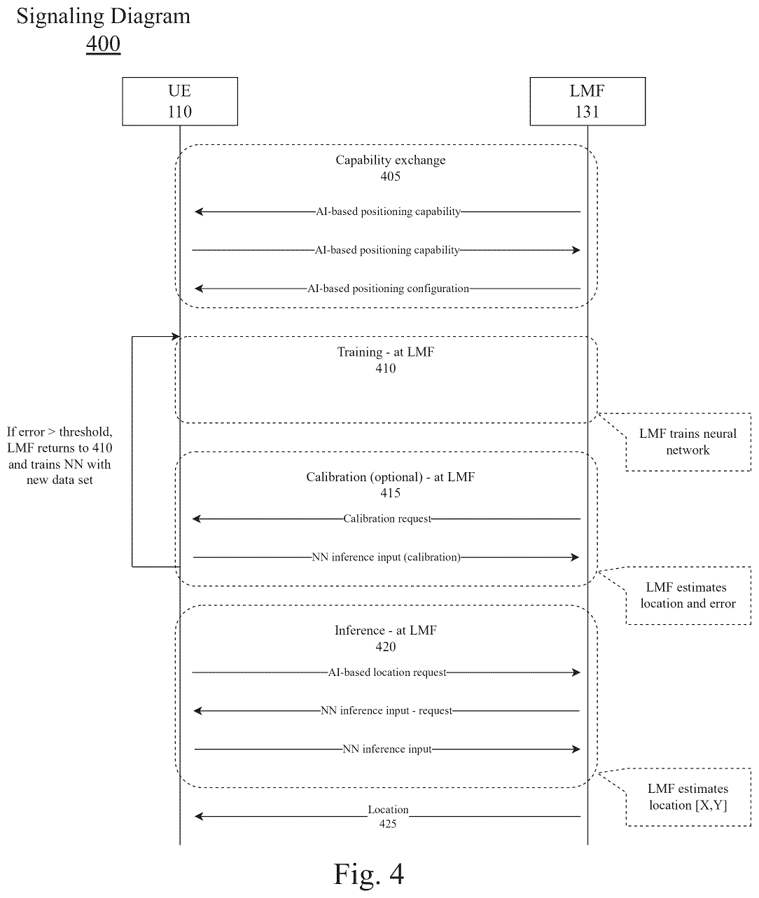

FIG. 4 shows a signaling diagram 400 for AI-based UE positioning according to a second option where the training and inference phases of the AI processes are performed at the LMF according to various exemplary embodiments. The diagram 400 shows one example of the second option, however, alternative embodiments will also be described.

Box 405 shows a capability signaling exchange between the UE and the gNB/LMF to indicate UE and network capability. The capability exchange of 405 can be similar to the capability exchange of 305 of the diagram 300.

Box 410 shows a training phase for the AI-based positioning neural network. The LMF can initiate the training phase after the capability exchange. In this option, no signaling is required between the UE and the LMF to initiate the training phase, as the training is performed at the LMF. The LMF can use a first training data set, e.g., data set index x=0, for the initial training and, if the calibration phase below results in an error exceeding the threshold, the training phase can be repeated with a different training data set, e.g., data set index x=1.

Box 415 shows an optional calibration phase for the AI-based positioning neural network. For the calibration phase, the LMF can use another positioning mechanism to compare to the AI-based position determination to assess the accuracy of the AI model within some error threshold. For example, in some embodiments, the LMF can identify a calibration location [X, Y] based on any of the LMF-assisted RAT-independent techniques (e.g., GNSS or GPS) or (b) RAT-dependent techniques (e.g., time difference of arrival (TDOA)) defined in 3GPP Rel-16 or Rel-17. In other embodiments, the calibration location [X, Y] can be manual, e.g., a specific location defined in the network as a positioning reference and reported to the LMF by the UE.

In this example, to perform the AI-based position determination, the LMF requests for neural network inference input (e.g., channel response, L1-RSRP, beam direction) and estimates location and error based on the NN inference input received from the UE. The LMF can request the NN inference input (e.g., channel response) and calibration positions [X, Y] from specific reference UEs or positioning reference cells. If the error is greater than a pre-determined threshold value, the LMF returns to the training phase of 410 and uses a new training data set, e.g., data set index x=1, to train the NN.

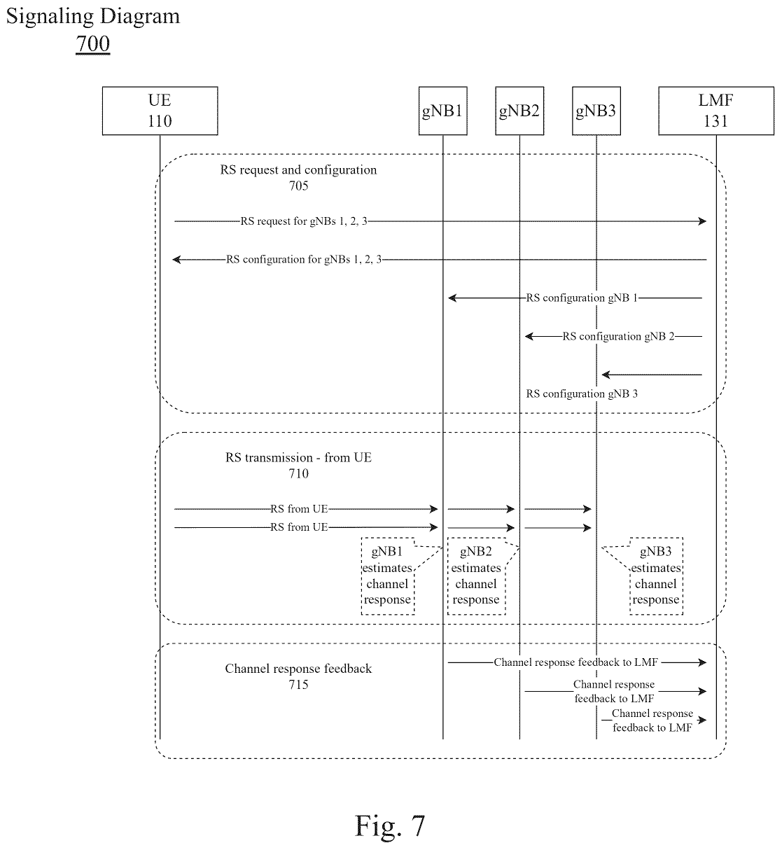

In one example, the channel response can be acquired at the UE (from DL RS transmitted from one or more positioning gNBs/TRPs) and the UE can transmit the channel response feedback to the LMF as the NN inference input. In another example, the channel response can be acquired at the gNBs/TRPs (from UL RS transmitted from the UE) and the gNBs/TRPs can transmit the channel response feedback to the LMF. These examples will be described in greater detail below with respect to FIGS. 6-7.

In alternative embodiments, the training and calibration location determination of 410-415 can be done offline, e.g., when the UE accesses a positioning reference point as described above. The UE(s) used for training the model could be different from the UEs used for calibration and inference.

Box 420 shows an inference phase for the AI-based positioning neural network. After the NN is trained and optionally calibrated, the NN can be used for LMF-based positioning of the UE. The UE transmits a request for AI-based positioning and receives, from the LMF, an NN inference input request. The UE can transmit the NN inference input (e.g., channel response feedback) to the LMF and the LMF estimates the UE location [X, Y]. The RS used for the NN inference input can be periodic, aperiodic or semi-persistent.

Signal 425 shows an optional step where the LMF sends the determined position to the UE.

According to the third option for training/inference, the training is performed at the LMF and the inference is performed at the UE. Relative to the first and second options, the third option provides a tradeoff between processing steps performed at the UE and the LMF.

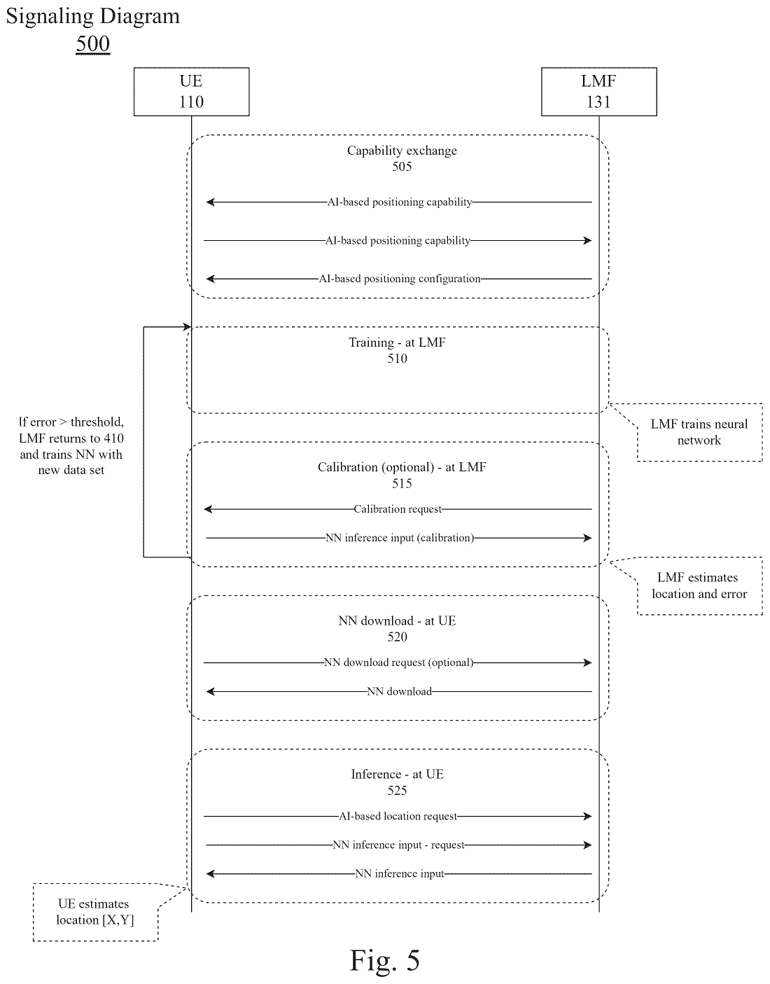

FIG. 5 shows a signaling diagram 500 for AI-based UE positioning according to a third option where the training phase of the AI process is performed at the LMF and the inference phase of the AI process is performed at the UE according to various exemplary embodiments. The diagram 400 shows one example of the third option, however, alternative embodiments will also be described.

Box 505 shows a capability signaling exchange between the UE and the gNB/LMF to indicate UE and network capability. The capability exchange of 505 can be similar to the capability exchange of 305 of the diagram 300 and/or 405 of the diagram 400.

Box 510 shows a training phase for the AI-based positioning neural network. The LMF can initiate the training phase after the capability exchange. Similar to 410 of FIG. 4, in this option, no signaling is required between the UE and the LMF to initiate the training phase, as the training is performed at the LMF. The LMF can use a first training data set, e.g., data set index x=0, for the initial training and, if the calibration phase below results in an error exceeding the threshold, the training phase can be repeated with a different training data set, e.g., data set index x=1.

Box 515 shows an optional calibration phase for the AI-based positioning neural network. Similar to 415 of FIG. 4, for the calibration phase, the LMF can use another positioning mechanism to compare to the AI-based position determination to assess the accuracy of the AI model within some error threshold. For example, in some embodiments, the LMF can identify a calibration location [X, Y] based on any of the LMF-assisted RAT-independent techniques (e.g., GNSS or GPS) or (b) RAT-dependent techniques (e.g., time difference of arrival (TDOA)) defined in 3GPP Rel-16 or Rel-17. In other embodiments, the calibration location [X, Y] can be manual, e.g., a specific location defined in the network as a positioning reference. The calibration location can be provided as feedback from the UE.

To perform the AI-based position determination, the LMF requests for neural network inference input (e.g., Channel response, L1-RSRP, beam direction) and estimates location and error based on the NN inference input received from the UE. The LMF can request the NN inference input (e.g., channel response) and associated positions [X, Y] from specific reference UEs or positioning reference cells. If the error is greater than a pre-determined threshold value, the LMF returns to the training phase of 510 and uses a new training data set, e.g., data set index x=1, to train the NN.

Box 520 shows the UE receiving the trained and optionally calibrated NN. After the NN is trained and optionally calibrated, the NN can be provided to the UE from the LMF for UE-based positioning at the UE. In the example shown in FIG. 5, the NN download is UE-initiated by the UE sending a request to the LMF for the NN download. However, in other embodiments, the NN download can be LMF-initiated. In one embodiment, the NN can be downloaded offline from a positioning reference unit (e.g., kiosk), via, e.g., a high speed wireline link, a Bluetooth connection, a near field communication (NFC) link, a WiGig link (e.g., 802.11ad/ay), an ultra-wideband (UWB) link, etc.

Box 525 shows an inference phase for the AI-based positioning neural network. In this example, the UE transmits a request for AI-based positioning and also transmits a request for NN inference input. The UE receives, from the LMF, the NN inference input, e.g., some reference signals from which the UE can derive the parameters that are input into the trained neural network. The UE can estimate the UE location [X, Y] based on the received RS. The RS used for the NN inference input can be periodic, aperiodic or semi-persistent.

According to the fourth option, the training is performed at the UE and the inference is performed at the LMF. Currently, the fourth option is not considered particularly viable. However, those skilled in the art will ascertain that the fourth option could be used if desired.

As described above, according to the various options for training/inference of the AI-based positioning, the NN inference input can comprise the channel response for DL reference signals (acquired at the UE) or the channel response for UL reference signals (acquired at one or more gNBs)

When DL reference signals are used to acquire the channel response, the RS can be, e.g., CSI-RS or PRS. The UE acquires the channel response from multiple gNBs by receiving RS from each of the multiple gNBs. The LMF controls the RS configuration process.

FIG. 6 shows a signaling diagram 600 for channel response acquisition at the UE for identifying NN inference input for UE positioning according to various exemplary embodiments. The diagram 600 shows the LMF 131 and three gNBs (gNBs 1, 2, 3) that are configured as positioning cells for the UE 110. However, those skilled in the art will ascertain that a greater or lesser number of gNBs can be used for UE positioning according to the type of NN, the type of channel response used as input for the NN, etc.

Box 605 shows the request (optional) and configuration of the DL RS used for the channel response acquisition. In some embodiments, as shown in 605, the UE can initiate the channel acquisition process by requesting the RS from the LMF. In this example, the UE sends the request to the LMF using a positioning protocol and the LMF configures the RS at different gNBs, e.g., gNB 1, gNB 2 and gNB 3. Any positioning protocol may bay used, for example, a Long Term Evolution (LTE) positioning protocol (LPP), a New Radio positioning protocol A (NRPPa), etc.

In an alternative embodiment, the UE sends the request to an associated gNB, e.g., a serving gNB. The gNB relays the request to the LMF and the LMF configures the RS at the different gNBs. In other embodiments, the UE request for RS is not needed and the LMF can initiate the RS configuration.

The RS can be configured by the LMF according to any of the following three options. In a first option, the LMF sends the configuration of the RS to each positioning TRP/gNB separately and to the UE directly using a positioning protocol. In a second option, the LMF sends the RS configuration to each positioning TRP/gNB, and each gNB sends the respective configuration to the UE. For the second option, the UE needs to be connected to the gNB configuring the RS. In a third option, the LMF sends the RS configuration to each positioning TRPs/gNBs and all the configurations to the serving gNB associated with the UE. The associated gNB sends the configuration of all the RS from all the positioning TRPs/gNBs to the UE.

Box 610 shows the UE reception of the RS from the gNBs. The gNBs send the reference signals based on the configuration from the LMF. The UE estimates the channel response based on the received RS.

If the UE is performing the inference phase of the NN then the UE can use the channel response estimation as input to the trained network. If the LMF is performing the inference phase of the NN, then the UE can transmit the channel response feedback to the LMF.

In some embodiments, for example, when the UE performs the training and/or inference phases of the AI-based positioning, the UE can use the channel response estimation directly as input for NN inference. When the UE is estimating the channel response during calibration of the NN, the UE can estimate the UE position and further determine an error value to assess the quality of the trained NN. When the UE is in the inference phase, the UE can estimate the UE position in [X, Y] coordinates.

In other embodiments, for example, when the LMF performs the inference phase of the AI-based positioning, the UE can provide the channel response estimation as feedback to the LMF. The LMF can trigger the feedback of the UE channel response. In one option, the feedback can be provided directly to the LMF using a positioning protocol. In another option, the feedback can be provided to the associated gNB (e.g., a serving gNB), which relays the feedback for all the gNBs to the LMF. In this option, the feedback can be provided using existing L1 CSI feedback processes. In still another option, the feedback for each gNB is provided to the respective gNB that transmitted the RS using the existing L1 CSI feedback processes, and each of these gNBs relays the respective feedback to the LMF. In still another option, the feedback is provided to each gNB using quantized time domain channel impulse response.

When UL reference signals are used to acquire the channel response, the RS can be, e.g., sounding reference signals (SRS) or positioning SRS (P-SRS). In some embodiments, the SRS may be non-precoded SRS. One or more TRPs/gNBs acquires the channel response from RS transmitted from the UE. The LMF controls the RS configuration process.

FIG. 7 shows a signaling diagram 700 for channel response acquisition at one or more positioning TRPs/gNBs for identifying NN inference input for UE positioning at the LMF according to various exemplary embodiments. The diagram 700 shows the LMF 131 and three gNBs (gNBs 1, 2, 3) that are configured as positioning cells for the UE 110. However, those skilled in the art will ascertain that a greater or lesser number of gNBs can be used for UE positioning according to the type of NN, the type of channel response used as input for the NN, etc.

Box 705 shows the request (optional) and configuration of the RS used for channel acquisition in the AI-based positioning method. In some embodiments, as shown in 705, the UE can initiate the channel response acquisition process by requesting the RS from the LMF. In this example, the UE sends the request directly to the LMF using a positioning protocol and the LMF configures the reception RS at different gNBs, e.g., gNB 1, gNB 2 and gNB 3.

In an alternative embodiment, the UE sends the request to an associated gNB, e.g., a serving gNB. The gNB relays the request to the LMF and the LMF configures the RS reception at the different gNBs.

In other embodiments, the UE request for RS is not needed and the LMF can initiate the RS configuration. The RS can be configured by the LMF by sending the configuration of the RS to each positioning TRP/gNB separately and to the UE directly using a positioning protocol or by sending the RS configuration to each positioning TRPs/gNBs and all the configurations to the serving gNB associated with the UE. The associated gNB sends the uplink RS configuration to the UE.

Box 710 shows the UE transmission of the RS to the gNBs based on the configuration(s). Each gNB estimates the channel response based on the received RS. In one embodiment, the UL RS can be transmitted to the respective gNBs at the same time, e.g., if the gNB beams are aligned or in single sector scenarios. In another embodiment, the UL RS can be transmitted to the respective gNBs at different times, e.g., to accommodate beam directionality of different gNBs.

Box 715 shows the channel response feedback from the TRPs/gNBs to the LMF. In these embodiments, the LMF is performing the inference phase of the NN and can use the channel response estimation(s) as input to the trained network.

In the following, the training/inference options described above are further associated with the channel response acquisition options described above in the methods 800-1000.

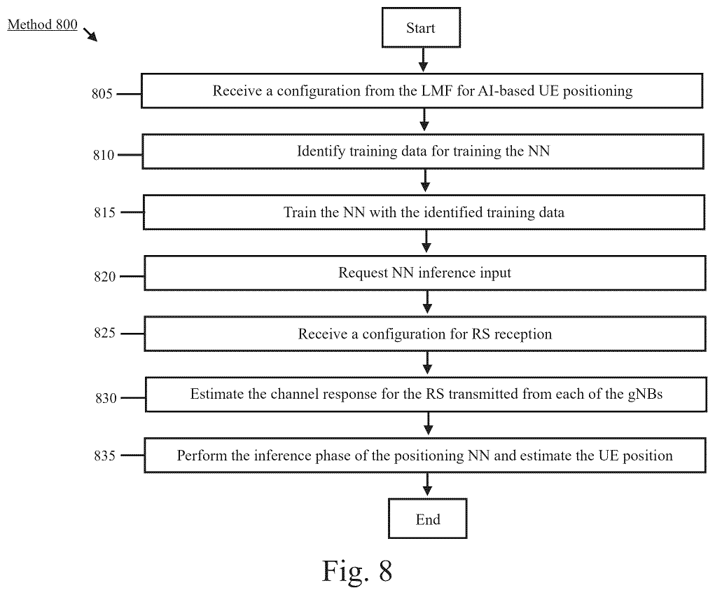

FIG. 8 shows a method 800 for AI-based UE positioning using a neural network (NN) where the training and inference phases of the AI process are performed at the UE according to various exemplary embodiments.

In 805, the UE receives a configuration from the LMF (e.g., via a serving gNB) for AI-based UE positioning. The configuration can be received after a UE positioning capability exchange with the LMF.

In 810, the UE identifies training data for training the NN. In one option, the training data is identified based on historical data stored at the UE. For example, one or more sets of training data can be generated based on the results of prior UE positioning methods, for example, using legacy methods such as TDOA. In another option, the training data is received from the LMF via a download from the serving gNB. This training data may be received in response to a UE request. In still another option, the training data is received from a positioning reference unit, e.g., a kiosk, that is configured to provide the training data via, e.g., a high speed wireline link, a Bluetooth connection, a near field communication (NFC) link, a WiGig link (e.g., 802.11ad/ay), an ultra-wideband (UWB) link,.

In 815, the UE trains the neural network with the identified training data.

In 820, the UE requests NN inference input. The inference input for the NN comprises channel response estimations determined from DL RS received at the UE from one or more gNBs. The channel response could comprise, e.g., L1-RSRP, beam direction, etc. Thus, the request can include, in some embodiments, one or more different types of reference signal (e.g., CSI-RS for CSI, CSI-RS for beam management, or PRS) for deriving the desired channel response. In some embodiments, the request can include a preferred TRP (e.g., cell ID) for the reference signals.

The UE may send the request to the LMF directly using a positioning protocol, or the UE may send the request to an associated base station, e.g., a serving gNB, that relays the request to the LMF.

When the request is received at the LMF, the LMF can determine the configuration of RS to transmit to the UE. Based in part on the parameters included in the request, the LMF can select a number of TRPs (e.g., gNBs) to use for the RS transmission and coordinate the RS transmissions from the respective gNBs to the UE. The LMF can configure each of the gNBs separately for the RS transmission. In some embodiments, the LMF can initiate the RS configuration without the request.

In 825, the UE receives a configuration for RS reception. In one embodiment, the LMF configures the UE directly using a positioning protocol via a serving gNB. In another embodiment, each of the gNBs are configured by the LMF and each gNB configures the UE with its respective RS (this option requires the UE to be connected to each of the gNBs). In still another embodiment, a serving gNB receives the configurations of all the gNBs being used in the positioning method, and the serving gNB configures the UE for the RS from all the gNBs.

In 830, the UE estimates the channel response for the RS transmitted from each of the gNBs (e.g., gNBs 1, 2 and 3). The channel response estimation can comprise, e.g., RSRP, beam direction, etc. The channel response estimation can be used as the input for the inference phase of the NN.

In 835, the UE performs the inference phase of the positioning NN and estimates the UE position. If the position estimation is for calibration purposes, the UE also estimates an error for the location estimation provided by the AI model relative to a calibration location determined by other methods. In some embodiments, to determine the calibration location, the UE can use a RAT-independent positioning technique (e.g., GNSS) or a RAT-dependent positioning technique (e.g., TDOA). In other embodiments, the UE can receive the calibration location from a positioning reference point, e.g., a kiosk.

It is noted that, in these embodiments, the channel response is estimated only at the UE based on DL RS, i.e., no complementary process is described in which the gNB/LMF estimates the channel response of UL RS and provides feedback to the UE. However, this process may also be used if desired.

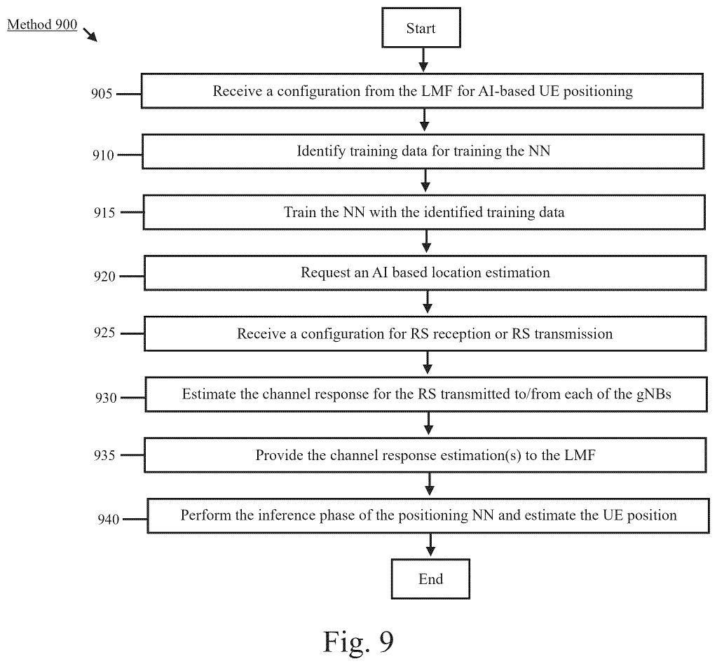

FIG. 9 shows a method 900 for AI-based UE positioning using a neural network (NN) where the training and inference phases of the AI process are performed at the LMF according to various exemplary embodiments.

In 905, the UE receives a configuration from the LMF (e.g., via a serving gNB) for AI-based UE positioning. The configuration can be received after a UE positioning capability exchange with the LMF.

In 910, the LMF identifies training data for training the NN.

In 915, the LMF trains the neural network with the identified training data.

In 920, the UE requests an AI based location estimation. The inference input for the NN comprises channel response estimations determined from either DL RS received at the UE from one or more gNBs or UL RS transmitted from the UE to the one or more gNBs. The channel response could comprise, e.g., L1-RSRP, beam direction, etc. Thus, the request can include, in some embodiments, one or more different types of reference signal (e.g., CSI-RS for CSI, CSI-RS for beam management, PRS, SRS) for deriving the desired channel response. In some embodiments, the request can include a preferred TRP (e.g., cell ID) for the reference signals. The UE may send the request to the LMF directly using a positioning protocol, or the UE may send the request to an associated base station, e.g., a serving gNB, that relays the request to the LMF.

When the request is received at the LMF, the LMF can determine the configuration of RS to transmit to or receive from the UE. Based in part on the parameters included in the request, the LMF can select a number of TRPs (e.g., gNBs) to use for the RS transmission/reception, and coordinate the RS transmissions/receptions to/from the respective gNBs to/from the UE. The LMF can configure each of the gNBs separately for the RS transmission/reception.

In 925, the UE receives a configuration for RS reception (DL RS from the positioning TRPs/gNBs) or RS transmission (UL RS to the positioning TRPs/gNBs). In one embodiment, the LMF configures the UE directly using a positioning protocol via a serving gNB. In another embodiment, each of the gNBs are configured by the LMF and each gNB configures the UE with its respective RS (this option requires the UE to be connected to each of the gNBs). In still another embodiment, a serving gNB receives the configurations of all the gNBs being used in the positioning method, and the serving gNB configures the UE for the RS to/from all the gNBs.

In 930, the UE or the positioning gNBs estimate the channel response for the RS transmitted to/from each of the gNBs (e.g., gNBs 1, 2 and 3). The channel response estimation can comprise, e.g., RSRP, beam direction, etc.

In 935, the channel response estimation(s) are provided to the LMF from the UE/gNBs.

In 940, the LMF performs the inference phase of the positioning NN and estimates the UE position. If the position estimation is for calibration purposes, the LMF also estimates an error for the location estimation provided by the AI model relative to a calibration location determined by other methods. In some embodiments, to determine the calibration location, the LMF can use a RAT-independent positioning technique (e.g., GNSS) or a RAT-dependent positioning technique (e.g., TDOA). In other embodiments, the LMF can receive the calibration location from the UE or via a positioning reference point, e.g., a kiosk.

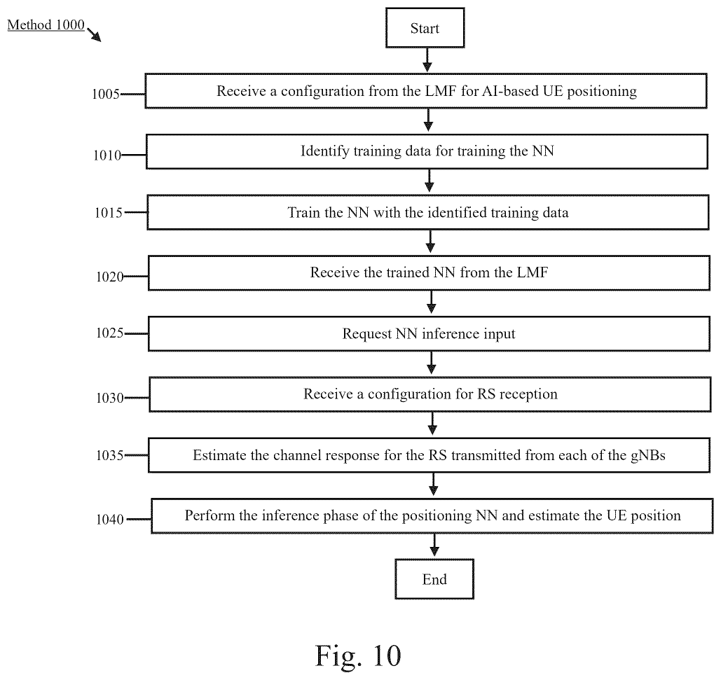

FIG. 10 shows a method 1000 for AI-based UE positioning using a neural network (NN) where the training phase of the AI process is performed at the LMF and the inference phase of the AI process is performed at the UE according to various exemplary embodiments.

In 1005, the UE receives a configuration from the LMF (e.g., via a serving gNB) for AI-based UE positioning. The configuration can be received after a UE positioning capability exchange with the LMF.

In 1010, the LMF identifies training data for training the NN.

In 1015, the LMF trains the neural network with the identified training data.

In 1020, the UE receives the trained NN from the LMF. The UE can optionally request the trained NN, or the NN provision can be LMF-initiated. In one embodiment, the UE can download the trained NN offline from a positioning reference unit.

In 1025, the UE requests NN inference input. As described above in 820, the inference input for the NN comprises channel response estimations determined from DL RS received at the UE from one or more gNBs. The UE may send the request to the LMF directly using a positioning protocol, or the UE may send the request to an associated base station, e.g., a serving gNB, that relays the request to the LMF. From the request, the LMF can determine the configuration of RS to transmit to the UE from one or more positioning TRPs/gNBs.

In 1030, the UE receives a configuration for RS reception according to the embodiments discussed above in 825.

In 1035, the UE estimates the channel response for the RS transmitted from each of the gNBs (e.g., gNBs 1, 2 and 3).

In 1040, the UE performs the inference phase of the positioning NN and estimates the UE position.

In this example, the UE performs only the inference phase and does not perform the training phase. Thus, if the trained NN is to be calibrated, the calibration is performed at the LMF. In this scenario, the LMF receives the channel response feedback to perform the calibration inference phase, which could be feedback for DL RS that are configured in accordance with the method 1000 or for UL RS that are configured in accordance with the method 900. If the position estimation is for calibration purposes, the LMF also estimates an error for the location estimation provided by the AI model relative to a calibration location determined by other methods.

### EXAMPLES

In a first example, a method performed by a user equipment (UE), comprising receiving a configuration from a location management function (LMF) for an artificial intelligence (AI) based UE positioning method using a neural network (NN), identifying a first training data set for training the NN, training the neural network with the first training data set, requesting NN inference input, receiving a configuration for downlink (DL) reference signal (RS) reception on one or more positioning cells, estimating a channel response for the received DL RS from the one or more positioning cells, using the channel response as the NN inference input and estimating the UE position.

In a second example, the method of the first example, further comprising transmitting a request for the first training data set to the LMF and receiving the first training data set from the LMF.

In a third example, the method of the second example, wherein the request for the first training data includes an identification of a type of DL RS to use to estimate the channel response.

In a fourth example, the method of the first example, further comprising receiving the first training data set from the LMF without a specific request from the UE.

In a fifth example, the method of the first example, further comprising determining the first training data set from historical data stored at the UE.

In a sixth example, the method of the first example, further comprising receiving the first training data set from a physical positioning reference point via a wireline link, a Bluetooth connection, a near field communication (NFC) link, a WiGig link or an ultra-wideband (UWB) link.

In a seventh example, the method of the first example, wherein the NN inference input is one of periodic, aperiodic or semi-persistent.

In an eighth example, the method of the first example, further comprising identifying a calibration location to calibrate the trained NN, estimating the UE location based on NN inference input for calibration, determining whether the error between the calibration location and the UE location based on the NN inference input for calibration is greater than a threshold and when the error is greater than the threshold, re-training the neural network with second training data.

In a ninth example, the method of the eighth example, wherein the calibration location is identified based on a radio access technology (RAT) independent positioning technique or a RAT dependent positioning technique.

In a tenth example, the method of the ninth example, wherein the calibration location is identified from a physical positioning reference point.

In an eleventh example, the method of the first example, wherein the first training data is received from a first LMF instance and the configuration for DL RS reception is received from a second LMF instance.

In a twelfth example, the method of the first example, wherein the request for the NN inference input includes a preferred cell for the DL RS reception and a preferred type for the DL RS.

In a thirteenth example, the method of the first example, wherein the request for the NN inference input is transmitted to the LMF using a positioning protocol.

In a fourteenth example, the method of the first example, wherein the request for the NN inference input is transmitted to a serving cell.

In a fifteenth example, the method of the first example, wherein the configuration for the DL RS reception is received from the LMF using a positioning protocol.

In a sixteenth example, the method of the first example, wherein the configuration for the DL RS reception is received from each of the one or more positioning cells.

In a seventeenth example, the method of the first example, wherein the configuration for the DL RS reception is received from a serving cell for each of the one or more positioning cells.

In an eighteenth example, a processor of a user equipment (UE) configured to perform any of the operations of the first through seventeenth examples.

In a nineteenth example, a user equipment (UE) comprises a transceiver configured to communicate with a network and a processor communicatively coupled to the transceiver and configured to perform any of the operations of the first through seventeenth examples.

In a twentieth example, a method performed at a location management function (LMF), comprising transmitting a configuration to a user equipment (UE) for an artificial intelligence (AI) based UE positioning method using a neural network (NN), wherein the UE identifies a first training data set for training the NN and trains the neural network with the first training data set, receiving a request from the UE for NN inference input, and transmitting a configuration to the UE for downlink (DL) reference signal (RS) reception on one or more positioning cells, wherein the UE estimates a channel response for the received DL RS from the one or more positioning cells, uses the channel response as the NN inference input and estimates the UE position.

In a twenty first example, the method of the twentieth example, further comprising receiving a request for the first training data set from the UE and transmitting the first training data set from the LMF.

In a twenty second example, the method of the twenty first example, wherein the request for the first training data includes an identification of a type of DL RS to use to estimate the channel response.

In a twenty third example, the method of the twentieth example, further comprising transmitting the first training data set to the UE without a specific request from the UE.

In a twenty fourth example, the method of the twentieth example, wherein the request for the NN inference input includes a preferred cell for the DL RS reception and a preferred type for the DL RS.

In a twenty fifth example, the method of the twentieth example, wherein the request for the NN inference input is received from the UE using a positioning protocol.

In a twenty sixth example, the method of the twentieth example, wherein the configuration for the DL RS reception is transmitted to the UE using a positioning protocol.

In a twenty seventh example, the method of the twentieth example, wherein the LMF is one of included in a 5G New Radio (NR) core network (CN) or included in a device providing a sidelink (SL) connection to the UE.

In a twenty eighth example, a location management function (LMF) configured to perform any of the operations of the twentieth through twenty seventh examples.

In a twenty ninth example, a method performed by a user equipment (UE), comprising receiving a configuration from a location management function (LMF) for an artificial intelligence (AI) based UE positioning method using a neural network (NN), wherein the LMF identifies a first training data set for training the NN and trains the neural network with the first training data set, receiving a configuration for downlink (DL) reference signal (RS) reception on one or more positioning cells, estimating a channel response for the received DL RS from the one or more positioning cells, transmitting the channel response to the LMF as the NN inference input, wherein the LMF estimates the UE position and receiving the UE position estimation from the LMF.

In a thirtieth example, the method of the twenty ninth example, further comprising identifying a calibration location to calibrate the trained NN and transmitting the calibration to the LMF, wherein the LMF estimates the UE location based on NN inference input for calibration, determines whether the error between the calibration location and the UE location based on the NN inference input for calibration is greater than a threshold, and, when the error is greater than the threshold, re-trains the neural network with second training data.

In a thirty first example, the method of the thirtieth example, wherein the calibration location is identified based on a radio access technology (RAT) independent positioning technique or a RAT dependent positioning technique.

In a thirty second example, the method of the thirtieth example, wherein the calibration location is identified from a physical positioning reference point.

In a thirty third example, the method of the twenty ninth example, wherein the configuration for the DL RS reception is received from the LMF using a positioning protocol.

In a thirty fourth example, the method of the twenty ninth example, wherein the configuration for the DL RS reception is received from each of the one or more positioning cells.

In a thirty fifth example, the method of the twenty ninth example, wherein the configuration for the DL RS reception is received from a serving cell for each of the one or more positioning cells.

In a thirty sixth example, a user equipment (UE) comprises a transceiver configured to communicate with a network and a processor communicatively coupled to the transceiver and configured to perform any of the operations of the twenty ninth through thirty fifth examples.

In a thirty seventh example, a method performed by a location management function (LMF), comprising training a neural network (NN) using a first training data set for an artificial intelligence (AI) based user equipment (UE) positioning method, receiving, from a UE, a request for AI-based positioning, sending, to the UE, an NN inference input request comprising a configuration for downlink (DL) reference signal (RS) reception on one or more positioning cells, receiving, from the UE, a channel response for the received DL RS from the one or more positioning cells, wherein the channel response is the NN inference input and estimating the UE position using the NN based on the NN inference input.

In a thirty eighth example, the method of the thirty seventh example, further comprising sending the UE position estimation to the UE.

In a thirty ninth example, the method of the thirty seventh example, further comprising identifying a calibration location to calibrate the trained NN and transmitting the calibration to the LMF, wherein the LMF estimates the UE location based on NN inference input for calibration, determines whether the error between the calibration location and the UE location based on the NN inference input for calibration is greater than a threshold, and, when the error is greater than the threshold, re-trains the neural network with second training data.

In a fortieth example, the method of the thirty ninth example, wherein the calibration location is identified based on a radio access technology (RAT) independent positioning technique or a RAT dependent positioning technique.

In a forty first example, the method of the thirty ninth example, wherein the calibration location is identified from a physical positioning reference point.

In a forty second example, the method of the thirty seventh example, wherein the configuration for the DL RS reception is received from the LMF using a positioning protocol.

In a forty third example, the method of the thirty seventh example, wherein the configuration for the DL RS reception is received from each of the one or more positioning cells.

In a forty fourth example, the method of the thirty seventh example, wherein the configuration for the DL RS reception is received from a serving cell for each of the one or more positioning cells.

In a forty fifth example, a location management function (LMF) configured to perform any of the operations of the thirty seventh through forty fourth examples.

In a forty sixth example, a method performed by a user equipment (UE), comprising receiving a configuration from a location management function (LMF) for an artificial intelligence (AI) based UE positioning method using a neural network (NN), wherein the LMF identifies a first training data set for training the NN and trains the neural network with the first training data set, receiving a configuration for uplink (UL) reference signal (RS) transmission to one or more positioning cells, transmitting the UL RS to the one or more positioning cells and receiving a UE position estimation from the LMF.

In a forty seventh example, the method of the forty sixth example, further comprising identifying a calibration location to calibrate the trained NN and transmitting the calibration to the LMF, wherein the LMF estimates the UE location based on NN inference input for calibration, determines whether the error between the calibration location and the UE location based on the NN inference input for calibration is greater than a threshold, and, when the error is greater than the threshold, re-trains the neural network with second training data.

In a forty eighth example, the method of the forty seventh example, wherein the calibration location is identified based on a radio access technology (RAT) independent positioning technique or a RAT dependent positioning technique.

In a forty ninth example, the method of the forty seventh example, wherein the calibration location is identified from a physical positioning reference point.

In a fiftieth example, the method of the forty sixth example, wherein the configuration for the UL RS reception is received from each of the one or more positioning cells.

In a fifty first example, the method of the forty sixth example, wherein the configuration for the UL RS reception is received from a serving cell for each of the one or more positioning cells.

In a fifty second example, a user equipment (UE) comprises a transceiver configured to communicate with a network and a processor communicatively coupled to the transceiver and configured to perform any of the operations of the forty sixth through thirty fifty first examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
receiving a configuration from a location management function (LMF) for an artificial intelligence (AI) based UE positioning method using a neural network (NN), wherein the LMF identifies a first training data set for training the NN and trains the neural network with the first training data set;
receiving a configuration for downlink (DL) reference signal (RS) reception on one or more positioning cells;
estimating a channel response for the received DL RS from the one or more positioning cells;
transmitting the channel response to the LMF as the NN inference input, wherein the LMF estimates the UE position; and
receiving the UE position estimation from the LMF.

2. The processor of claim 1, wherein the operations further comprise:
identifying a calibration location to calibrate the trained NN; and
transmitting the calibration to the LMF, wherein the LMF estimates the UE location based on NN inference input for calibration, determines whether the error between the calibration location and the UE location based on the NN inference input for calibration is greater than a threshold, and, when the error is greater than the threshold, re-trains the neural network with second training data.

3. The processor of claim 2, wherein the calibration location is identified based on a radio access technology (RAT) independent positioning technique or a RAT dependent positioning technique.

4. The processor of claim 2, wherein the calibration location is identified from a physical positioning reference point.

5. The processor of claim 1, wherein the configuration for the DL RS reception is received from the LMF using a positioning protocol.

6. The processor of claim 1, wherein the configuration for the DL RS reception is received from each of the one or more positioning cells.

7. The processor of claim 1, wherein the configuration for the DL RS reception is received from a serving cell for each of the one or more positioning cells.

8. A location management function (LMF) of a cellular core network configured to perform operations comprising:
training a neural network (NN) using a first training data set for an artificial intelligence (AI) based user equipment (UE) positioning method;
receiving, from a UE, a request for AI-based positioning;
sending, to the UE, an NN inference input request comprising a configuration for downlink (DL) reference signal (RS) reception on one or more positioning cells;
receiving, from the UE, a channel response for the received DL RS from the one or more positioning cells, wherein the channel response is the NN inference input; and
estimating the UE position using the NN based on the NN inference input.

9. The LMF of claim 8, wherein the operations further comprise:
sending the UE position estimation to the UE.

10. The LMF of claim 8, wherein the operations further comprise:
identifying a calibration location to calibrate the trained NN; and
transmitting the calibration to the LMF, wherein the LMF estimates the UE location based on NN inference input for calibration, determines whether the error between the calibration location and the UE location based on the NN inference input for calibration is greater than a threshold, and, when the error is greater than the threshold, re-trains the neural network with second training data.

11. The LMF of claim 10, wherein the calibration location is identified based on a radio access technology (RAT) independent positioning technique or a RAT dependent positioning technique.

12. The LMF of claim 10, wherein the calibration location is identified from a physical positioning reference point.

13. The LMF of claim 8, wherein the configuration for the DL RS reception is received from the LMF using a positioning protocol.

14. The LMF of claim 8, wherein the configuration for the DL RS reception is received from each of the one or more positioning cells.

15. The LMF of claim 8, wherein the configuration for the DL RS reception is received from a serving cell for each of the one or more positioning cells.

16. A processor of a user equipment (UE) configured to perform operations comprising:
receiving a configuration from a location management function (LMF) for an artificial intelligence (AI) based UE positioning method using a neural network (NN), wherein the LMF identifies a first training data set for training the NN and trains the neural network with the first training data set;
receiving a configuration for uplink (UL) reference signal (RS) transmission to one or more positioning cells;
transmitting the UL RS to the one or more positioning cells; and
receiving a UE position estimation from the LMF.

17. The processor of claim 16, wherein the operations further comprise:
identifying a calibration location to calibrate the trained NN; and
transmitting the calibration to the LMF, wherein the LMF estimates the UE location based on NN inference input for calibration, determines whether the error between the calibration location and the UE location based on the NN inference input for calibration is greater than a threshold, and, when the error is greater than the threshold, re-trains the neural network with second training data.

18. The processor of claim 17, wherein the calibration location is identified based on a radio access technology (RAT) independent positioning technique or a RAT dependent positioning technique.

19. The processor of claim 17, wherein the calibration location is identified from a physical positioning reference point.

20. The processor of claim 16, wherein the configuration for the UL RS reception is received from one of (i) each of the one or more positioning cells or (ii) a serving cell for each of the one or more positioning cells.

21. (canceled)
